(19) United States
(12) Patent Application Publication
(10) Pub. No.: US 2024/0310842 A1
(43) Pub. Date: Sep. 19, 2024

(54) Work Machine

(71) Applicant: Putzmeister Engineering GmbH, Aichtal (DE)

(72) Inventors: Nils BUKSCHAT, Deizisau (DE); Tobias HUTH, Stuttgart (DE); Christian ZIEMENS, Stuttgart (DE); Hans-Bernd DUERR, Herrenberg (DE); Matthias BRAUN, Stuttgart (DE)

(21) Appl. No.: 18/576,804

(22) PCT Filed: Jul. 5, 2022
(86) PCT No.: PCT/EP2022/068617

§ 371 Date: Jan. 5, 2024

(30) Foreign Application Priority Data
Jul. 6, 2021 (DE) 10 2021 207 088.4
Jul. 6, 2021 (DE) 10 2021 207 089.2

(51) Int. Cl. G05D 1/222; G05D 105/05; G05D 107/90; G05D 111/30

(52) U.S. Cl. CPC G05D 1/2235; G05D 2105/05; G05D 2107/90; G05D 2111/30

(57) ABSTRACT

A work machine includes a moving boom, an ultra-wideband system (UWB) having one UWB tag and a number of UWB anchors, a marking apparatus that can be handled by a user and can be operated by the user, and a control unit. The UWB tag is mounted on the marking apparatus. The control unit is designed so as, when the marking apparatus is operated, to store a position of the UWB tag ascertained by way of the UWB system at the time of the operation and to control the operation of the mobile work machine on the basis of the ascertained position.

### BACKGROUND AND SUMMARY

DE 20 2019 107 198 U1 discloses an apparatus with a lifting apparatus and a locating apparatus based on ultra-wideband (UWB) technology.

The invention is based on the object of providing a work machine that allows the safest operation possible.

The, in particular mobile, work machine comprises a conventional boom.

The work machine further comprises an ultra-wideband (UWB) system. The UWB system comprises at least one conventional UWB tag, often also referred to as a marker. The at least one UWB tag may for example be a conventional cell phone with integrated UWB technology or be integrated in a cell phone.

The UWB system further comprises a number of UWB anchors. The number of UWB anchors may be between 1 and 10, for example. The UWB tag can be mounted on a further machine or is mounted during operation of the work machine. The further machine is able to move relative to the work machine, i.e. a distance between the further machine and the work machine may be fundamentally changed during the operation of the work machine.

UWB technology (ultra-wideband technology) is a radio-based communication technology for close range for transmitting data for position determination indoors and outdoors. The position of the UWB tag or tags is determined by determining the time of flight of ultra-wideband signals having frequencies of more than 1.5 GHz between the UWB tag or tags and the UWB anchors. The ultra-wideband signals typically have a bandwidth of between 0.1 GHz and 10 GHz, in particular between 0.5 GHz and 5 GHz, particularly preferably between 0.8 GHz and 1.2 GHz. The frequency of the ultra-wideband signals is typically between 1.5 GHz and 20 GHz, in particular between 2 GHz and 15 GHz, particularly preferably between 3 GHz and 10 GHz. The energy of the ultra-wideband signals is typically between −100 dBm/Hz and −1 dBm/Hz, in particular between −90 dBm/Hz and −10 dBm/Hz, particularly preferably between −60 dBm/Hz and −30 dBm/Hz. In addition, reference may also be made to the relevant specialist literature.

The work machine further comprises a marking apparatus that can be handled by a user and can be operated by the user, the UWB tag being mounted on the marking apparatus and/or being part of the marking apparatus.

The work machine comprises a control unit, for example in the form of a microprocessor controller, that is coupled to the UWB system for the purpose of data interchange. The control unit is designed so as, when the marking apparatus is operated, to store a position of the UWB tag ascertained by means of the UWB system at the time of the operation and to control the operation of the mobile work machine on the basis of the ascertained position. When the marking apparatus is operated at further times, the control unit is designed to store a respective position of the UWB tag ascertained by means of the UWB system at the time of the further operation and to control the operation of the mobile work machine on the basis of the ascertained positions.

Positions or locations within the context of this description are understood to mean in particular positions or locations in space and may be described in a 3-dimensional coordinate system, for example, in particular described in a Cartesian 3-dimensional coordinate system.

In one embodiment, the control unit is designed to control a movement of the boom on the basis of the stored position(s). The boom may conventionally comprise multiple boom segments that move relative to one another, in particular move rotationally relative to one another, the control unit being designed to move the boom segments relative to one another, by means of suitable control of conventional boom segment actuators. The boom segments may be connected to one another using/via joints, which means that the boom is able to be positioned in different boom positionings/boom poses. Different boom positionings/boom poses may be distinguished by their rotation angle positioning in relation to a vertically extending axis (vertical axis) and/or distinguished by the angles between the boom segments.

In one embodiment, the control unit is designed to control a movement of the boom on the basis of the stored position(s) in such a way that the boom, in particular as a whole, does not adopt a position or positioning that corresponds to the stored position(s). If multiple positions are stored, the control unit may be designed to take the stored positions as a basis for calculating a geometry, for example in the form of a volume that the boom as a whole does not enter.

In one embodiment, the control unit is designed to generate a warning signal when the boom approaches the stored position(s).

The control unit can be designed to determine a current position of the boom or a boom tip on the basis of sensor data that represent a current boom pose. To this end, the work machine may comprise for example sensors for producing sensor data, the sensor data representing angles between the boom segments and/or representing a rotation angle positioning of the boom. Alternatively or additionally, further UWB tags may be mounted on the boom, in particular on the boom tip, in order to determine the position of the boom, the control unit in this case being designed to determine a current position of the boom or of the boom tip on the basis of a current position of the further UWB tags ascertained by means of the UWB system.

In one embodiment, the marking apparatus comprises an operating device, for example in the form of a button, a key, etc., by means of which the marking apparatus can be operated.

In one embodiment, the marking apparatus comprises a rod, the operating device being mounted at one end of the rod and the UWB tag being mounted at the opposite end of the rod.

In one embodiment, the rod is telescopable or is a telescopic rod.

In one embodiment, the work machine is a truck-mounted concrete pump.

The use of a (truck-mounted) concrete pump on a construction site is very demanding for the operator of the truck-mounted concrete pump. When the boom is moving, collisions with other items situated on the construction site, for example scaffolding, can occur. The local environment leads to restriction of the action space.

The present invention may be used to adhere to the geometric restriction of the action space of the boom.

According to the invention, a UWB tag is mounted for example on a telescopic rod provided with an activation button. The UWB anchors are located on the work machine or on the boom, for example.

The rod or the UWB tag may be taken by a user to items that are intended to be recorded as obstacles. Operating the activation button sends the current position of the UWB tag to the control unit, as a result of which this position of the obstacle may be recorded.

It is then possible to continue marking the next obstacle as appropriate.

In this way, for example a three-dimensional map of the geometric restrictions of the action space of the boom that arise in the environment of the work machine, for example as a result of items, scaffolding, etc., may be created. If a collision is imminent, audible or visual feedback may be output to the operator of the work machine, for example. Furthermore, a collision may be prevented for example by reducing the speed of movement of the boom and finally stopping it completely.

Further aspects of the invention are described below.

### Leg Positioning Detection

To operate a concrete pump, the outriggers thereof need to be extended on the basis of a desired radius of action of the concrete pump. The final positioning of the outriggers governs the range of the boom or arm of the concrete pump and also the space requirements for support and is dependent on the surroundings. Particularly in urban areas, the outriggers cannot always be fully extended. In order to take the outriggers to the optimum position, the position thereof needs to be measured during extension. To this end, the invention involves UWB tags being mounted on the outriggers. UWB anchors are suitably arranged at known positions on the concrete pump and/or in the environment of the concrete pump. The UWB system can then be used to measure and monitor the position of the outriggers.

### Camera Drone Tracking for 3D Photographs

To ensure that a concrete pump is positioned in an optimum manner and that the boom or arm thereof is subsequently adjusted on a construction site, it is desirable to have an accurate geometric model of the current situation on the construction site. By way of example, this includes items and scaffolding that are on the construction site. These may be potential obstacles when moving the boom or arm. The invention can be used to produce a valid, three-dimensional, virtual image of the construction site. This is accomplished by mounting a UWB tag on a remote-controlled drone equipped with a camera. UWB anchors are suitably arranged at known positions on the concrete pump and/or in the environment of the concrete pump. The drone can then be flown over the construction site. The position of the UWB tag is constantly ascertained by means of the UWB system, an evaluation algorithm being used to associate the position of the drone with the current image data therefrom, with the result that a valid three-dimensional image of the construction site can be produced. This can then in turn be used for example to find an optimum setup position for the concrete pump and/or to allow collision-free trajectory planning for the boom.

### Sensor Fusion for Arm Angle Sensors and UWB

Moving the boom or arm of a concrete pump requires accurate measurement of the current configuration and position of the boom or arm. To achieve this, particularly sensors are currently used on the joints of the boom segments, which measure the angles thereof. Should these sensors fail, measurement of the arm position is no longer possible. The invention can be used to measure the position of the boom or arm even more accurately and to still allow determination of the position of the boom or arm even if one or more angle sensors should fail. To this end, UWB tags are mounted on the boom, or the segments thereof. UWB anchors are suitably arranged at known positions on the concrete pump and/or in the environment of the concrete pump. UWB position determination for the UWB tags and sensor fusion, based on a mathematical model of the boom and an estimation algorithm, are used according to the invention to combine the position signals from the UWB system and the available angle sensors. This results in improved determination of the position of the boom, and the redundant measurement allows the position to be determined even if one or more angle sensors fail.

### Setup Location for a Truck-Mounted Concrete Pump

If a truck-mounted concrete pump is used to concrete a large surface area, the work area is limited by the maximum range of the boom. The choice of setup position defines the surface area that is able to be reached around the truck-mounted concrete pump. The aim is to reach the whole area to be concreted preferably without relocating. The invention can be used to find the best possible position for the truck-mounted concrete pump. To this end, the construction site area of the surface area to be concreted is equipped with UWB anchors. The anchors are used to extensively monitor the construction site area by means of the UWB system and to fix the position of the UWB tags. Whereas the UWB anchors are arranged at fixed, known positions, the UWB tags are able to be moved flexibly in space, and so the current position of said tags may be determined. With a UWB tag in their hand, a machine operator can walk up and down an outermost edge of the surface area to be concreted, for example. This boundary of the surface area is located and recorded. The machine operator then indicates the planned setup location for the truck-mounted concrete pump, and it is calculated whether the range of the arm is sufficient to cover the whole surface area to be concreted from this setup location. If this condition is satisfied, setup of the truck-mounted concrete pump can be started. If this condition is not satisfied, the machine operator can have alternative setup locations checked by the software. Alternatively, it is also possible for setup locations that allow the whole surface area to be covered by the boom to be suggested.

### Machine Cockpit AR/VR Display

A concrete pump is normally used on a construction site and therefore in a complex environment. For the workers and in particular the operator of the concrete pump, it is therefore important to maintain a good overview of the machine to be operated at all times. Furthermore, a radio remote control that may be available permits increased flexibility, but results in the operator's eyes regularly being diverted from the machine to the display of the radio remote control. The machine is unmonitored for this time, which presents an increased safety risk. The invention allows uninterrupted monitoring of the machine and at the same time of the machine data regardless of one's whereabouts on the construction site. To this end, UWB tags are attached to all machine elements to be monitored. UWB anchors are suitably arranged at known positions on the concrete pump and/or in the environment of the concrete pump. This allows the position of the equipped machine elements to be determined at all times. The information is conditioned so that it is displayed three-dimensionally on a display element that is installed on the machine or that is in AR/VR (Augmented/Virtual Reality) glasses. In particular the display in augmented reality glasses permits the driver to keep their eyes on the visible and invisible elements of the machines at the same time.

### Rapid Boom Moving

To control or adjust the speed of an end hose on the basis of radius, or up to a permissible speed, a boom pose needs to be detected using sensors. The invention can be used to provide a cheaper alternative to the sensors used at present in order to allow the boom to be moved at constant speed. According to the invention, UWB tags are mounted on the boom. UWB anchors are suitably arranged at known positions on the concrete pump and/or in the environment of the concrete pump. Position determination may thus be used to determine the boom pose at any time and to control/adjust the boom pose on the basis thereof, in order to allow a high moving speed. The UWB tags form a cheap alternative to the inclination sensors used at present.

### Warning on Leaving the Radio Range

A concrete pump is normally operated by means of a radio remote control. When the range of the radio remote control is exceeded, communication problems or even failure of the communication between the radio remote control and the concrete pump may arise. Furthermore, a driver must not be out of sight of an end hose. The invention can be used to prevent a communication failure with respect to the radio remote control and/or to monitor whether the driver is in sight of the end hose. To this end, a UWB tag is mounted on or integrated in a radio remote control that can be used to control the support posts of a concrete pump. UWB anchors are suitably arranged at known positions on the concrete pump and/or in the environment of the concrete pump. UWB position determination is then used to fix the position of the radio remote control, and so an imminent communication failure can be communicated to the operator, for example visually or audibly, before the range of the radio remote control is exceeded. This allows a failure to be prevented and/or optionally the machine to be shut down for safety reasons in the event of the range being exceeded. Furthermore, it is possible to ensure that the driver is still in sight of the end hose.

### Data Logging for Motion Profile Between Operator Control Elements

A concrete pump is normally operated using multiple operator control elements that are distributed over the concrete pump and control various actuators of the machine. During preparation, an operator needs to go to the relevant control panel in order to move the specific required actuator. Frequent readjustment can therefore lead to frequently repeated changes of position for the operator. The resultant motion profile of the operator may accordingly be extensive and suggests a less-than-optimum arrangement of the operator control elements. The invention can be used to arrange the operator control elements in such a way that the motion profile of the operator is optimized and therefore the time for preparing the machine may be shortened. According to the invention, UWB position determination is used to record the motion profile, or the position history, of the operator. On the basis of the recorded motion profile, the operator control elements are then arranged in such a way that they lead to an optimized motion profile.

### Pig Location in the Concrete Delivery Line

When cleaning a concrete pump, what are known as “pigs” are normally used, which are inserted into the concrete delivery line and travel through it by producing pressure and in this way clean it. It is often desirable to detect the current whereabouts of the pig inside the line. According to the invention, a pig is provided with a UWB tag. UWB anchors are suitably arranged at known positions on the concrete pump and/or in the environment of the concrete pump. UWB position measurement can then be used to determine the exact position of the pig in three-dimensional space. In this way, a boom pose can be taken as a basis for determining the position of the pig inside the pipeline.

### Range Prediction for the Boom

When setting up a concrete pump, the outriggers installed on the concrete pump are normally extended. How far the outriggers need to be extended is dependent on how far the boom of the concrete pump needs to be extended during operation. A lot of practical knowledge is generally needed in order to assess in advance how far the outriggers need to be extended. A subsequent correction can lead to undesirable delays in setting up the concrete pump. The invention can be used to ascertain a valid assessment of whether the current outrigger configuration is sufficient, or how far the outriggers of the concrete pump need to be extended, in order to ensure a safe setup. This is accomplished by arranging multiple UWB tags on the boundaries of the surface area to be concreted. Alternatively or additionally, a UWB tag may be mounted on a radio remote control or on a rod and the respective boundary position marked by means of button input. UWB anchors are suitably arranged at known positions on the concrete pump and/or in the environment of the concrete pump. Since the position of the UWB tags (point of placement) relative to the UWB anchors (machine/environment of the machine) is able to be ascertained by means of the UWB system, a position of the boom, as corresponds to the marked end position, may be automatically calculated. It is therefore possible to make a qualitative statement about the current support in regard to the necessary boom excursion. Alternatively, the necessary boom excursion can be used to ascertain a weight distribution for the machine and thus to provide automated output of an estimate of the extent to which the outriggers should be extended.

### Allocation of Concrete in Formwork

The following situation may be predefined: formwork needs to be filled with various types of concrete. There are areas within the formwork in which there is provision for different concrete than in the rest. For static or visual reasons, it is sometimes necessary to put different grades of concrete into common formwork. The invention can now be used to ensure correct allocation of the concrete grade to the position in the formwork. To this end, a work area around the formwork is provided with reference stations, i.e. UWB anchors. Whereas each of the UWB anchors is arranged at a fixed known position, the UWB tags are able to be moved flexibly in space and the current whereabouts may be determined. The outer edges of the formwork and the end hose of the concrete pump are each provided with UWB tags. It is thus possible to constantly establish the positions thereof. On that basis, the orientation with respect to one another, i.e. end hose with respect to formwork, may be calculated and for example displayed on a screen. The operator of the concrete pump may then easily establish whether they are currently keeping the end hose with the grade of concrete flowing out at the correct place therefor in the formwork.

Construction Progress in Combination with BIM

A construction site may be planned, implemented and run using what is known as BIM “Building Information Modeling”. This involves a virtual model of the construction project being generated. The invention can be used to monitor the construction progress and to represent it in the virtual model. To this end, the UWB anchors are arranged at fixed locations on the construction site. The UWB tags are arranged at characteristic positions that represent the construction progress in the best possible way, for example the highest point of a shell. UWB position determination may then be used to match the virtual model of the construction site to reality.

### Monitoring of Defined Areas on a Construction Site

A construction site, especially of increasing size, has a lot of construction vehicles, tools and already delivered construction material temporarily stored on it until the next use. Furthermore, there are regularly obstacles on a construction site, such as for example excavations and walls, and/or areas that are not supposed to be entered. These obstacles and hazardous areas are not always at the same position. As such, it is not permitted to be in the work area of excavators or beneath booms of concrete pumps or cranes, for example. Construction workers and other persons on the construction site need to be warned about these obstacles or prevented from entering hazardous areas. This is possible by means of the invention. To this end, the construction site area is provided with UWB anchors. The UWB anchors may be used to extensively monitor the construction site area and to fix the position of UWB tags. Whereas the UWB anchors are arranged at a fixed known position, the UWB tags are able to be moved flexibly in the construction site area, and the current position may be determined by means of the UWB system. All obstacles and areas that cannot be entered are stored in a location system. Machines stored in the location system have a no-go area around them that is evaluated in the location system. If all persons on the construction site carry a UWB tag, for example as a type of wristwatch or in a manner integrated in their helmet, they may be located. If the location system registers a person in the danger area, it can warn this person about the obstacle or the area, for example by way of a sound or an LED lamp on the relevant tag or on the obstacle/machine. If the positions or locations of the construction vehicles and persons on the construction site are known, it is also possible for the location system to calculate the path of movement of the two in advance. If it registers a possible collision, it can warn both parties in good time via the tags, and said parties are able to react in order to prevent the collision.

Trajectory Optimization within Formwork

Introducing concrete into formwork by means of a concrete pump requires a specific approach depending on the concrete that is to be introduced. In particular the trajectory that the end hose of the concrete pump travels along may influence the quality of the component. The invention may be used to optimize the trajectory that is supposed to be taken within the formwork. To this end, UWB anchors are arranged in the closer surroundings of the formwork to be filled. Furthermore, UWB tags are arranged on the formwork boundaries for marking purposes. The trajectory may now be calculated either within the formwork or along the tags, and the end hose may accordingly be controlled such that the desired trajectory is travelled along.

### Trajectory Planning for the Arm

An advantage of a concrete pump is that the concrete may be introduced to the desired location with pinpoint accuracy by means of a boom or arm on which an end hose is mounted. Conventionally, the boom is controlled manually by the driver of the concrete pump and needs to be coordinated such that the end of the hose is as close as possible to the desired location. Moving the boom is a complex and generally time-consuming operation. The invention may be used to simplify and speed up moving the boom. To this end, a specific UWB tag is arranged at a starting point, an endpoint and at characteristic positions (e.g. bends and curves) in the formwork to be concreted. Furthermore, UWB anchors are mounted in the surrounding target region or on the boom itself. A trajectory planning method is used to automatically calculate a trajectory that is optimum in terms of time and/or energy. The arm is then moved along the calculated trajectory in an automated manner.

### Absolute Measurement of the Formwork or Target Positions

In a concrete precast factory, the formwork modules are moved to their prescheduled location on rails in a partially automated manner. The formwork is flexibly constructed from the modules. The concreting then takes place using a stationary concrete pump with a distribution boom. The invention can be used to move an end hose along the formwork in an automated manner in such a way that the concrete is evenly distributed. This task is intended to be automated with the invention described below. To this end, the work area around the formwork is provided with UWB anchors. The UWB tags are able to be moved flexibly in space, UWB technology being able to be used to determine the current whereabouts of the UWB tags. According to the invention, the UWB tags are then arranged at all the relevant points in the formwork, for example at corners and/or edges and/or cutouts for windows and doors. Furthermore, a UWB tag is arranged on the end hose. It is therefore possible to replicate the geometric structure or the shape of the formwork and to use a control system to define a work area for the end hose. The orientation of the end hose relative to the formwork is known, and so it may now move up and down the formwork and distribute the concrete under automatic control.

### Monitoring of the Surroundings During Operation of a Truck-Mounted Concrete Pump

While a (truck-mounted) concrete pump is operating, there are operating conditions in which there are for example walls or building roofs in the surroundings of the concrete pump. These are obstacles for the extending of the support legs and/or for the opening-out and movement of the boom. The invention can be used to protect components of the concrete pump against collisions with the surroundings in an automated manner. To this end, the construction site area or the truck-mounted concrete pump is equipped with UWB anchors. According to the invention, all moving components of the concrete pump, for example the outriggers and the joints of the boom, are equipped with UWB tags. This allows the position thereof to be ascertained by means of the UWB system at any time. Furthermore, obstacles in the surroundings, for example walls, building roofs or base opening, are likewise provided with UWB tags and located. If a control system of the concrete pump now registers that components of the machine and an obstacle are getting closer and closer, that is to say that the two positions or locations are approaching one another, the control system stops the movement of the components, in particular immediately, allowing collisions to be prevented.

### Collision Avoidance Between Concrete Pump and Cranes

The use of a movable/stationary concrete pump on a construction site or in precast factories is very demanding. When the boom is moving, collisions with other moving machines situated in the surroundings, in particular cranes, can occur. The local environment leads to restriction of the action space. The invention may be used to ensure that geometric restrictions of the action space of the arm are observed. To this end, UWB tags are mounted on the respective machines situated in the surroundings. UWB anchors are mounted on the concrete pump and/or on the boom. UWB position measurement may be used to locate other machines, even when they are moving. If a collision is imminent, audible or visual feedback is output or the collision is directly prevented by means of suitable control by reducing the speed of movement of the boom or stopping it completely.

The invention is described in detail below with reference to the drawing.

### BRIEF DESCRIPTION OF THE DRAWING

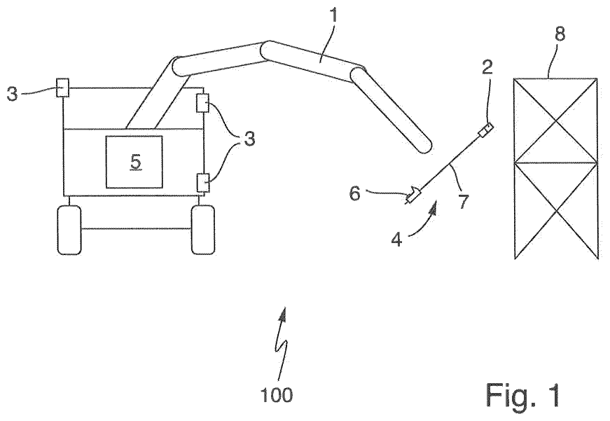

FIG. 1 is a highly schematic representation of a work machine with an ultra-wideband (UWB) system.

### DETAILED DESCRIPTION OF THE DRAWING

FIG. 1 shows a highly schematic representation of a work machine 100 in the form of a truck-mounted concrete pump with an ultra-wideband (UWB) system and a conventional multi-segment boom or arm 1.

The UWB system comprises one UWB tag 2 and three UWB anchors 3. It goes without saying that the UWB system may also comprise more than the three UWB anchors 3 shown.

The work machine 100 furthermore comprises a marking apparatus 4 that can be handled by a user and can be operated by the user, the UWB tag 2 being mounted on the marking apparatus 4.

The marking apparatus 4 comprises an operating device 6 in the form of a pushbutton switch by means of which the marking apparatus 4 can be operated.

The marking apparatus 4 comprises a telescopic rod 7, the operating device 6 being mounted at one end of the telescopic rod 7 and the UWB tag 2 being mounted at the opposite end of the telescopic rod 7.

The work machine 100 furthermore comprises a control unit 5 that is designed so as, when the marking apparatus 4 is operated, to store a position of the UWB tag 2 ascertained by means of the UWB system at the time of the respective operation and to control the operation of the mobile work machine 100 on the basis of the ascertained position(s).

The control unit 5 prevents the boom 1 from adopting or approaching positions that correspond to the stored positions. Additionally, a warning signal may be output when the boom 1 approaches the stored positions. The control unit may be designed to take the stored positions as a basis for calculating a more complex geometry that the boom 1 must not approach. In the simplest case, linear interpolation between two points may be used to ascertain a straight line that the boom must not approach. It goes without saying that the ascertained points may also be combined with one another by more complex algorithms in order to work out positions that are closed to the boom 1.

A user of the work machine 100 may for example use the marking apparatus 4 to learn the external dimensions of scaffolding 8 by marking corners of the scaffolding 8. The control unit 5 then takes the marked positions as a basis for working out a volume or a position cloud that the boom 1 must not approach.

1.-8. (canceled)

9. A work machine, comprising:
a moving boom;
an ultra-wideband (UWB) system comprising one UWB tag and a number of UWB anchors;
a marking apparatus that is handleable by a user and is operable by the user, the UWB tag being mounted on the marking apparatus; and
a control unit that is designed so as, when the marking apparatus is operated, to store a position of the UWB tag ascertained by the UWB system at the time of the operation and to control operation of the mobile work machine on the basis of the ascertained position.

10. The work machine as claimed in claim 9, wherein
the control unit is further designed to control a movement of the boom on the basis of the stored position.

11. The work machine as claimed in claim 10, wherein
the control unit is further designed to control a movement of the boom on the basis of the stored position such that the boom does not adopt a position that corresponds to the stored position.

12. The work machine as claimed in claim 9, wherein
the control unit is further designed to generate a warning signal when the boom approaches the stored position.

13. The work machine as claimed in claim 9, wherein
the marking apparatus comprises an operating device by which the marking apparatus is operable.

14. The work machine as claimed in claim 13, wherein
the marking apparatus comprises a rod,
the operating device is mounted at one end of the rod, and
the UWB tag is mounted at an opposite end of the rod.

15. The work machine as claimed in claim 14, wherein the rod is telescopable.

16. The work machine as claimed in claim 9, wherein the work machine is a truck-mounted concrete pump.
